(19) United States
(12) Patent Application Publication
(10) Pub. No.: US 2016/0282451 A1
(43) Pub. Date: Sep. 29, 2016

(54) LIDAR SYSTEM

(71) Applicant: Caterpillar Inc., Peoria, IL (US)

(72) Inventors: Mark Hartman, Edwards, IL (US); Nathaniel W. Hart, Dunlap, IL (US); Weston M. Taylor, Groveland, IL (US); Jeffrey L. Parker, Dunlap, IL (US)

(73) Assignee: Caterpillar Inc., Peoria, IL (US)

(21) Appl. No.: 15/172,922

(22) Filed: Jun. 3, 2016

(51) Int. Cl. G01S 7/486; G01S 17/10

(52) U.S. Cl. CPC G01S 7/4868; G01S 17/10

(57) ABSTRACT

A Light-detection and ranging (LIDAR) system for controlling a bias voltage is provided. The LIDAR system includes a light source configured to emit light pulses and a light sensor configured to receive light pulses transmitted by the light source and scattered by an object. A voltage source is provided to apply the bias voltage to the light sensor. The LIDAR system further includes a sensor configured to generate a signal indicative of a temperature of the light sensor. The LIDAR system includes a controller communicably coupled to the light source, the light sensor, the voltage source and the sensor. The controller is configured to receive the signal indicative of the temperature of the light sensor. Further, the controller is configured to measure the bias voltage currently applied to the light sensor. The voltage source is regulated based at least on the temperature of the photodiode and the measured bias voltage currently applied to the light sensor.

### TECHNICAL FIELD

The present disclosure relates to Light-Detection and Ranging (LIDAR) systems. More particularly, the present disclosure relates to a system for regulating a voltage source associated with a light sensor in the LIDAR system.

### BACKGROUND

Light-detection and ranging (LIDAR) is an optical remote sensing technology to acquire information of a surrounding environment. Typical operation of the LIDAR system includes illuminating objects in the surrounding environment with light pulses emitted from a light emitter, detecting light scattered by the objects using a light sensor such as photodiode, and determining information about the objects based on the scattered light. The time taken by light pulses to return to the photodiode can be measured, and a distance of the object can then be derived from the measured time. As the LIDAR system is typically configured to detect far-away objects, the light emitter is configured to send a strong laser pulse and the photodiode having a high sensitivity is used to accurately detect the object. For high sensitivity applications, an avalanche photodiode (APD) is generally used.

The performance of the LIDAR system is impacted by operating temperature. Specifically, at low temperatures, for example below 0 degrees Celsius, the APD available in the current market has very high sensitivity,

U.S. Pat. No. 9,048,370 describes a method for determining an operating bias voltage of a photodiode. The method includes detecting spurious signals and varying the bias voltage such that the frequency of occurrence of the spurious signals is minimized.

### SUMMARY

In an aspect of the present disclosure, a Light-detection and ranging (LIDAR) system for controlling a bias voltage is provided. The LIDAR system includes a light source configured to emit light pulses and a light sensor configured to receive light pulses transmitted by the light source and scattered by an object. A voltage source is provided to apply the bias voltage to the light sensor. The LIDAR system further includes a sensor configured to generate a signal indicative of a temperature of the light sensor. The LIDAR system includes a controller communicably coupled to the light source, the light sensor, the voltage source and the sensor. The controller is configured to receive the signal indicative of the temperature of the light sensor. Further, the controller is configured to measure the bias voltage currently applied to the photodiode. The voltage source is regulated by the controller based on the temperature of the photodiode, and the measured bias voltage currently applied to the light sensor.

### BRIEF DESCRIPTION OF DRAWINGS

FIG. 1 is a block diagram illustrating a LIDAR system, in accordance with an embodiment of the present disclosure;

FIG. 2 is a block diagram illustrating a controller to regulate a voltage source in the LIDAR system, in accordance with an embodiment of the present disclosure; and

FIG. 3 is a flow chart of a method for regulating the voltage source, in accordance with an embodiment of the present disclosure.

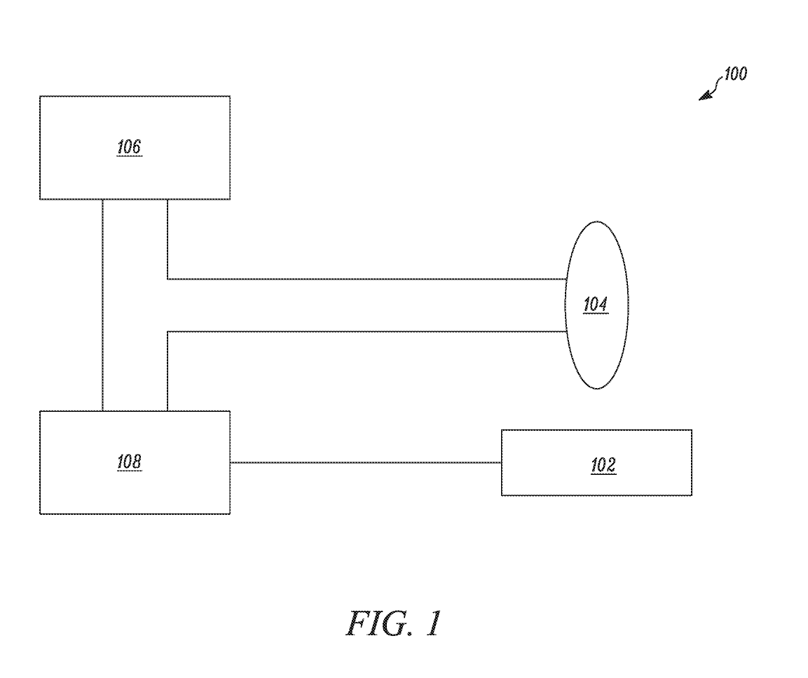

### DETAILED DESCRIPTION

Wherever possible, the same reference numbers will be used throughout the drawings to refer to same or like parts. FIG. 1 illustrates a Light-detection and ranging (LIDAR) system 100. The LIDAR system 100 determines information about an object in a surrounding environment by emitting a light pulse towards the object and detecting the scattered light pulses from the object. The LIDAR system 100 includes a light source 102 to emit light pulses. The light source 102 emits a laser light beam or laser pulses. The light source 102 may emit continuous laser pulses. The light source 102 may include light emitting diode (LED), gas laser, a chemical laser, a solid-state laser, or a semiconductor laser diode (“laser diode”), among other possible light types. The light source 102 may include any suitable number of and/or combination of laser devices. For example, the light source 102 may include multiple laser diodes and/or multiple solid-state lasers. The light source 102 emits light pulses of a particular wavelength, for example, 900 nm and/or in a particular wavelength range. For example, the light source 102 may include at least one laser diode to emit light pulses in a defined wavelength range. Moreover, the light source 102 emits light pulses in a variety of power ranges. However, it will be understood that other light sources can be used, such as those emitting light pulses covering other wavelengths of electromagnetic spectrum and other forms of directional energy.

After exiting the light source 102, light pulses may be passed through a series of optical elements. These optical elements may shape and/or direct the light pulses. In an exemplary embodiment, optical elements are provided to split the beam of light into a plurality of individual rays of light, which are directed onto a target object and/or area. Further, the light source 102 may be in a variety of housings and attached to a number of different bases and platforms associated with the LIDAR system 100. These include both stationary and mobile platforms such as vehicles or automated systems.

The LIDAR system 100 also includes a light sensor 104 to receive light pulses scattered from one or more objects (not shown) in the surrounding environment. The light sensor 104 detects particular wavelengths/frequencies of light, e.g., ultraviolet, visible, and/or infrared. The light sensor 104 detects light pulses at a particular wavelength and/or wavelength range, as used by the light source 102. In an embodiment, the light sensor 104 is a photodiode. The light sensor 104 converts light into a current or voltage signal. In particular, incoming light enters the light sensor 104 and creates charged carriers. Through the application of a bias voltage on the light sensor 104, the light pulses drive the voltage beyond a breakdown voltage to set charged carriers free, creating a measurable amount of electrical current. Thus, by measuring, the electrical current, the amount of light sensed by the light sensor 104 is derived.

In an example embodiment, the light sensor 104 may be an avalanche photodiode (APD). Through what is referred to as the “avalanche breakdown,” the charged carriers are accelerated in an electric field to produce additional carriers. In particular, a single photon that enters the APD 104 may generate hundreds or even thousands of carriers. Thus, a single photon can be sufficient to generate a constant current, measurable by other electronic devices. The light sensor 104 has been interchangeably referred to herein as the APD 104. The APD 104 is also used to sense light, but with a higher level of sensitivity. At higher sensitivity levels, the photodiode 104 is able to detect objects that are further away. However, sensitivity of the photodiode 104 may be impacted at extreme hot or cold ambient temperatures. For example, at low ambient temperature conditions, the light sensor 104 may be oversensitive. Therefore, it is desirable to control the sensitivity of the light sensor 104 for proper operation of the LIDAR system 100. The sensitivity of the APD 104 can be controlled by controlling the bias voltage that is applied to the APD 104.

The bias voltage in the APD 104 is much higher than in conventional photodiodes. By applying a high reverse bias voltage (for example, 100-200 V), the APD 104 is designed to experience the avalanche breakdown at specified voltages. The APD 104 allows each photon-generated carrier to be multiplied by avalanche breakdown, resulting in internal gain within the APD 104.

The light sensor 104 is positioned to capture at least a portion of the light pulses scattered back from the one or more objects in the surrounding environment. Although the light sensor 104 is shown, other types of devices for capturing at least a portion of the scattered light pulses can be used, such as a radiation detection element suitable for converting received electromagnetic energy into an electronic signal. For optical wavelengths, the light sensor 104 can be a common low-cost PN photodiode, or a PIN photodiode, an avalanche photodiode (APD), or a photomultiplier tube (PMT). In various embodiments, the light sensor 104 may include a plurality of APDs 104.

Referring to FIG. 1, the LIDAR system 100 further includes a voltage source 106 connected to the light sensor 104 to provide a bias voltage to the light sensor 104. The voltage source 106 may be any suitable voltage source that can manage, receive, generate, store, and/or distribute necessary voltage for the operation of the light sensor 104. For example, the voltage source 106 may be a battery capable of providing a bias voltage to the light sensor 104. In an example embodiment, the voltage source 106 may be capable of providing a bias voltage within the range of 80 volts to 280 volts. However, other ranges of voltages may also be used.

As shown in FIG. 1, the LIDAR system 100 includes a controller 108 communicably coupled to the light source 102, the light sensor 104, and the voltage source 106. In particular, the controller 108 regulates the voltage source 106 to apply a bias voltage to the light sensor 104 and vary the bias voltage. In one embodiment, the controller 108 regulates the voltage source 106 to apply bias voltages in increasing order. For example, the controller 108 regulates the voltage source 106 to increase the applied bias voltages substantially linearly. In another embodiment, the controller 108 regulates the voltage source 106 to decrease the applied bias voltage.

In various embodiments, the controller 108 may include one or more components (not shown) to control the light source 102. For example, the controller 108 may control the intensity of the emitted light pulses and triggering of the light source 102. Further, in various embodiments, the controller 108 may include various signal processing modules and control logic modules to process the information captured by the light sensor 104.

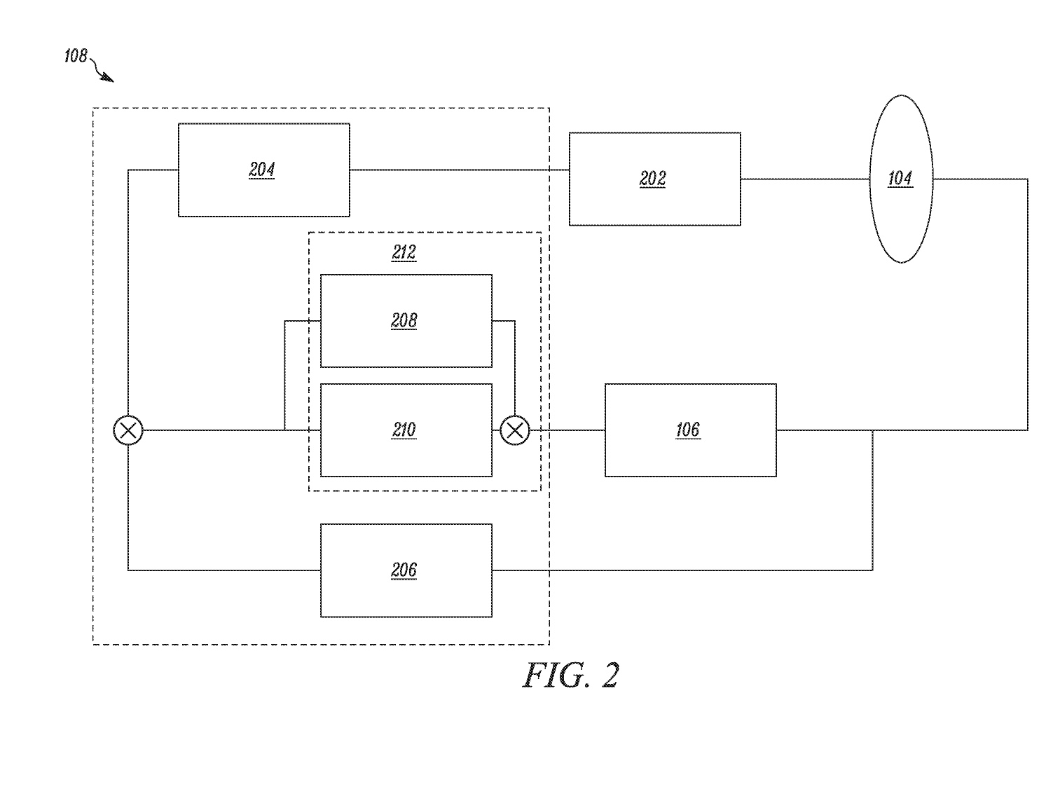

Referring to FIG. 2, a temperature sensor 202 is provided to measure the temperature of the light sensor 104. The temperature sensor 202 generates a signal indicative of the temperature of the light sensor 104. The temperature sensor 202 may be a thermistor or any other temperature sensor known in the art. The temperature sensor 202 may be in physical contact with the light sensor 104 or in close proximity to the light sensor 104 for measuring a temperature representative of the temperature of the light sensor 104. For example, the temperature sensor 202 may be disposed near the circuit board of the light sensor 104. In one embodiment, the photodiode 104 may be configured as an array of photodiodes. For example, the array of photodiodes may include “32” photodiodes arranged in various configurations known in the art. In such cases, the temperature sensor 202 may provide an average value of the temperature of the array of photodiodes. In another embodiment, the light sensor 104 may be configured as two arrays of photodiodes. The temperature sensor 202, in such case, may be multiple temperature sensors averaged to provide a relative temperature between the arrays of photodiodes.

As shown in FIG. 2, the controller 108 includes a temperature compensation module 204 connected to the temperature sensor 202. The signal generated by the temperature sensor 202 is provided to the temperature compensation module 204. The temperature compensation module 204 determines a target bias voltage based on the temperature of the light sensor 104. In one embodiment, the temperature compensation module 204 may include circuitry to generate a digital value of temperature based on the signal provided by the temperature sensor 202. Further, the temperature compensation module 204 may include a temperature to voltage map to determine the target bias voltage.

Additionally, other inputs may also he considered while regulating the voltage source 106. In one embodiment, a sensitivity level offset representing manufacturer's specifications, for example, bin characteristics, corresponding to the particular type of the light sensor 104 may also be used to regulate the voltage source 106. More specifically, the temperature compensation module 204 may receive an input corresponding to the sensitivity level offset associated with the light sensor 104. The temperature compensation module 204 determines the target bias voltage while taking into account the sensitivity level offset.

Referring to FIG. 2, the controller 108 includes a voltage monitoring module 206 to measure a present bias voltage indicating the bias voltage currently applied to the light sensor 104. The controller 108 generates an error signal indicating the difference between the present bias voltage and the target bias voltage. In one embodiment, the controller 108 controls the error signal using a proportional-integral (PI) controller 212. However, proportional controller, integral controller, derivative controller, or their combination as known in the art may be used to control the error signal. As shown in FIG. 2, the PI controller 212 includes a proportional component 208 which provides a “proportional” gain function for the error signal, so that small changes in bias voltage are made for small errors and larger changes in bias voltage are made for larger errors. Further, the PI controller 212 includes an integral component 210 which provides an “integral” function for the error signal, so that changes in bias voltage are made gradually (and more smoothly) over time. The PI controller 212 generates a control signal which is utilized by the controller 108 to regulate the voltage source 106. Thus, appropriate bias voltage is generated and applied to the light sensor 104 based on the temperature of the light sensor 104.

### INDUSTRIAL APPLICABILITY

The present disclosure is related to LIDAR systems for regulating the bias voltage of the light sensor 104 and provides a solution to overcome the impact of operating conditions such as, extreme low or high temperature conditions, on the light sensor 104.

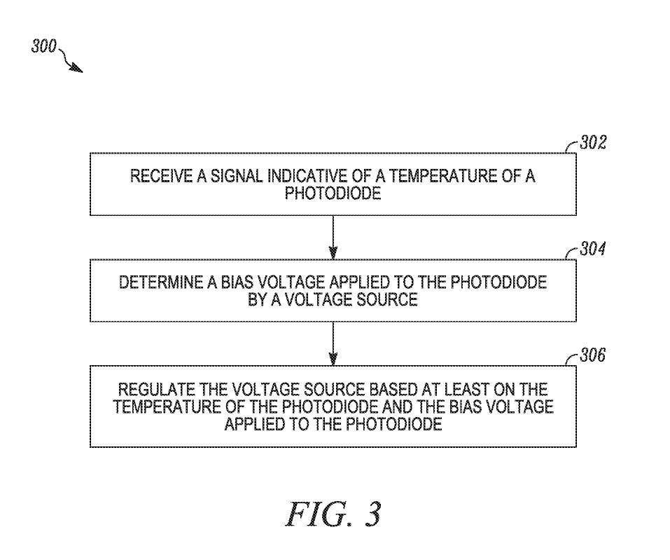

Referring to FIG. 3, a method 300 of working of the controller 108 of the LIDAR system 100 is illustrated. The LIDAR system 100 includes the light source 102, the light sensor 104, and the voltage source 106, The controller 108 is communicably coupled to the light source 102, the light sensor 104, and the voltage source 106. Further, the LIDAR system 100 includes the temperature sensor 202 to generate the signal indicative of the temperature of the light sensor 104. The temperature sensor 202 may be a thermistor or any other temperature sensor known in the art.

At step 302, the controller 108 receives the signal indicative of the temperature of the light sensor 104. Specifically, the controller 108 includes the temperature compensation module 204 to receive the signal indicative of the temperature of the light sensor 104 from the temperature sensor 202. The temperature compensation module 204 determines the target bias voltage based on the temperature of the light sensor 104.

At step 304, the controller 108 determines the bias voltage applied to the light sensor 104. Specifically, the controller 108 includes the voltage monitoring module 206 to provide a present bias voltage indicating the bias voltage currently applied to the light sensor 104.

At step 306, the controller 108 regulates the voltage source 106 based on the temperature of the light sensor 104 and the present bias voltage. Specifically, the controller 108 generates the error signal indicating the difference between the present bias voltage and the target bias voltage. In one embodiment, the controller 108 controls the error signal using the proportional-integral (PI) controller 212. The PI controller 212 generates a control signal which is applied to the voltage source 106. The controller 108 regulates the voltage source 106 based on the control signal. In other words, appropriate bias voltage is generated and applied to the light sensor 104 based on the temperature of the light sensor 104. Thus, despite temperature variations, a consistent sensitivity of the light sensor 104 can be maintained by appropriately varying the bias voltage.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A light-detection and ranging (LIDAR) system comprising:
a light source configured to emit light pulses;
a light sensor configured to receive light pulses transmitted by the light source and scattered by an object;
a voltage source configured to apply a bias voltage to the light sensor;
a sensor configured to generate a signal indicative of a temperature of the light sensor; and
a controller communicably coupled to the light source, the light sensor, the voltage source and the sensor, the controller configured to:
receive the signal indicative of the temperature of the light sensor;
measure the bias voltage applied to the light sensor; and
regulate the voltage source based at least on the temperature of the light sensor and the measured bias voltage applied to the light sensor.

2. The LIDAR system of claim 1, wherein the controller is configured to receive an input corresponding to a sensitivity level offset associated with the light sensor.
